(19) United States
(12) Patent Application Publication
(10) Pub. No.: US 2011/0051843 A1
(43) Pub. Date: Mar. 3, 2011

(54) TRANSMISSION CIRCUIT

(75) Inventors: Keitaro OTSUKA, Yokohama (JP); Takeshi INOUE, Yokohama (JP)

(73) Assignee: FUJITSU SEMICONDUCTOR LIMITED, Yokohama-shi (JP)

(21) Appl. No.: 12/868,721

(22) Filed: Aug. 25, 2010

(30) Foreign Application Priority Data
Aug. 27, 2009 (JP) 2009-197120

(51) Int. Cl. H04L 25/03; H04B 1/04

(52) U.S. Cl. 375/296; 455/114.2

(57) ABSTRACT

A transmission circuit includes: a first switch configured to select one of a first baseband signal and an oscillation signal; a second switch configured to select one of a second baseband signal and the oscillation signal; a first multiplier configured to multiply a first local frequency signal based on the oscillation signal by the signal selected by the first switch; a second multiplier configured to multiply a second local frequency signal based on the oscillation signal by the signal selected by the second switch; an adder configured to add an output from the first multiplier to an output from the second multiplier; and a correction circuit configured to correct one of the first baseband signal and the second baseband signal based on an output from the adder when the first switch and the second switch select the oscillation signal.

### CROSS-REFERENCE TO RELATED APPLICATIONS

This application claims the benefit of priority from Japanese Patent Application No. 2009-197120 filed on Aug. 27, 2009, the entire contents of which are incorporated herein by reference.

### BACKGROUND

1. FIELD

Embodiments discussed herein relate to a transmission circuit.

2. DESCRIPTION OF RELATED ART

A transmission circuit in a communication system includes a quadrature modulation circuit. The quadrature modulation circuit multiplies baseband signals, which are an I component and a Q component, by local frequency signals, the phase difference between the local frequency signals being π/2. In addition, the quadrature modulation circuit adds the multiplication results and outputs a high-frequency signal that is an intermediate frequency IF or a high frequency RF.

Related art is disclosed in Japanese Laid-Open Patent Publication No. 2006-41631, Japanese Laid-Open Patent Publication No. 2006-50331, and Japanese Laid-Open Patent Publication No. 2003-125014 or the like.

### SUMMARY

According to one aspect of the embodiments, a transmission circuit includes: a first switch configured to select one of a first baseband signal and an oscillation signal; a second switch configured to select one of a second baseband signal and the oscillation signal; a first multiplier configured to multiply a first local frequency signal based on the oscillation signal by the signal selected by the first switch; a second multiplier configured to multiply a second local frequency signal based on the oscillation signal by the signal selected by the second switch; an adder configured to add an output from the first multiplier to an output from the second multiplier; and a correction circuit configured to correct one of the first baseband signal and the second baseband signal based on an output from the adder when the first switch and the second switch select the oscillation signal.

The object and advantages of the invention will be realized and achieved by at least those features, elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary transmission circuit and an exemplary reception circuit;

FIG. 2 illustrates an exemplary transmission circuit;

FIG. 3 illustrates an exemplary transmission circuit;

FIG. 4 illustrates an exemplary correction circuit;

FIG. 5 illustrates an exemplary transmission circuit;

FIG. 6 illustrates exemplary signal waveforms in a transmission circuit; and

FIG. 7 illustrates exemplary transmission circuit.

### DESCRIPTION OF EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present.

A carrier leak may occur in an output signal from a quadrature modulation circuit due to voltage variations among circuit devices in a transmission circuit or a characteristic change of a multiplier based on a temperature change. Consequently, a bit error rate (BER) on a reception side may increase due to an occurrence of the carrier leak. Because the carrier leak corresponds to a DC offset component included in the output signal from the quadrature modulation circuit, input signals to the quadrature modulation circuit may be corrected based on a detection of such a DC offset component. However, the carrier leak additionally may occur in the frequency band of a local frequency existing in the frequency band of the output signal from the quadrature modulation circuit. Hence, a DC offset component that does not factor in the effect of the frequency band of the local frequency may not provide correction of the input signals to the quadrature modulation circuit as accurate as desired.

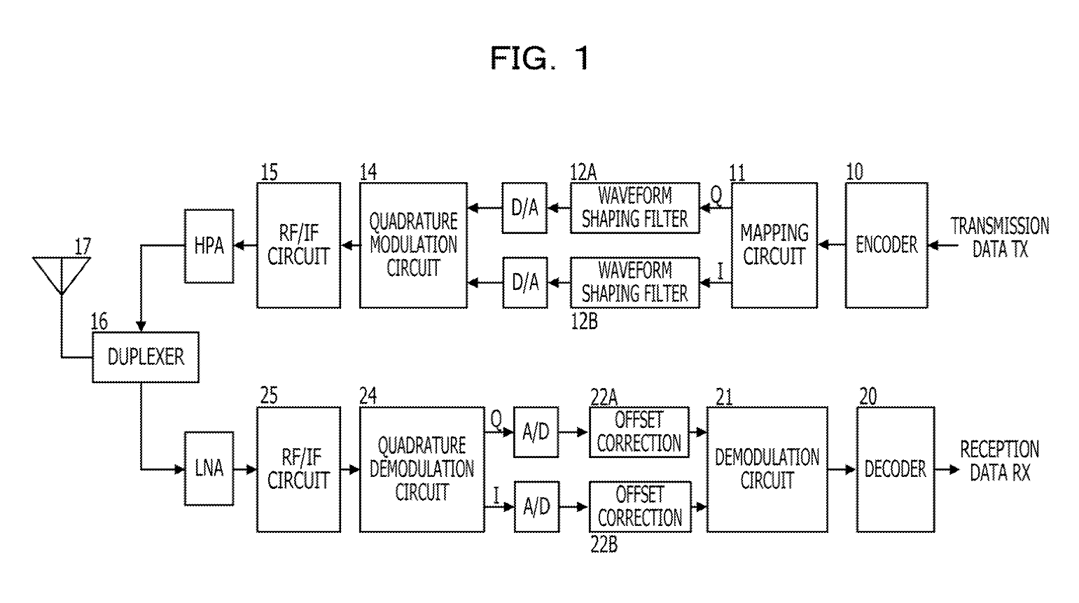

FIG. 1 illustrates an exemplary transmission circuit and an exemplary reception circuit. The transmission circuit includes an encoder 10, a mapping circuit 11, filters 12A and 12B, a D/A converter D/A, a quadrature modulation circuit 14, an RF/IF circuit 15, and a high power amplifier HPA. The encoder 10 encodes transmission data TX. The mapping circuit 11 maps encoded data to both a Q component and an I component. The filters 12A and 12B shape the waveforms of the I signal and the Q signal. The D/A converter D/A digital-analog-converts the waveform-shaped I signal and the waveform-shaped Q signal. The quadrature modulation circuit 14 multiplies the analog I signal and the analog Q signal by a local frequency signal and adds the multiplied I signal to the multiplied Q signal. The RF/IF circuit 15 up-converts the frequency of a quadrature-modulated transmission signal to a carrier frequency. The high power amplifier HPA amplifies an output from the RF/IF circuit 15. The amplified transmission signal is transmitted from an antenna 17 to a communication medium through a duplexer 16.

The reception circuit includes a low noise amplifier LNA, an RF/IF circuit 25, a quadrature demodulation circuit 24, an A/D converter A/D, offset correction circuits 22A and 22B, a demodulation circuit 21, and a decoder circuit 20. The low noise amplifier LNA amplifies a reception signal that is received by the antenna 17 and input through the duplexer 16. The RF/IF circuit 25 down-converts an output from the low noise amplifier LNA to an intermediate frequency. The quadrature demodulation circuit 24 quadrature-demodulates the down-converted signal using a local frequency signal. The A/D converter A/D analog-digital-converts the baseband signals of the demodulated I component and the demodulated Q component respectively. The demodulation circuit 21 demaps the baseband signals of the I component and the Q component. The decoder circuit 20 extracts reception data by decoding an output from the demodulation circuit.

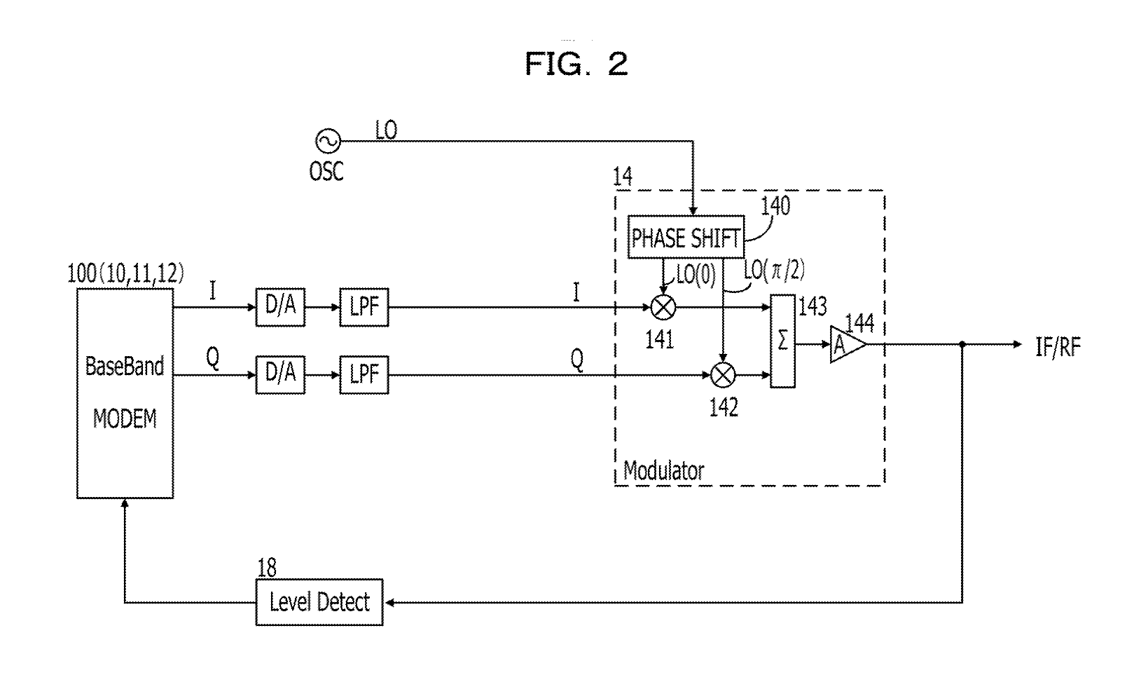

FIG. 2 illustrates an exemplary transmission circuit. The transmission circuit illustrated in FIG. 2 may be the transmission circuit illustrated in FIG. 1. The baseband MODEM 100 includes a digital signal processing circuit. The digital processing circuit includes the encoder 10, the mapping circuit 11, the waveform shaping filters 12A and 12B, the decoder 20, the demodulation circuit 21, and the offset correction circuits 22A and 22B, which are illustrated in FIG. 1. The baseband signal of a digital I component and the baseband signal of a digital Q component are output from the digital signal processing circuit 100.

The baseband signal of the I component and the baseband signal of the Q component are converted to analog signals respectively by digital-analog converters D/A. High-frequency quantization noise, which is generated in the D/A conversion, is removed from the converted analog signals by low-pass filters LPF.

The quadrature modulation circuit 14 includes a phase shifter 140 that generates a second local frequency signal LO (π/2) by shifting the phase of an oscillation signal LO, which has a local frequency generated by an oscillator OSC, by 90 degrees (π/2), first and second multipliers 141 and 142, an adder 143, and an amplifier 144. The first multiplier 141 may include a mixer that multiplies the baseband signal of the I component by a first local frequency signal LO (0), the phase of which is substantially the same as that of the oscillation signal LO. The second multiplier 142 may include a mixer that multiplies the baseband signal of the Q component by the second local frequency signal LO (π/2) that is obtained by shifting the phase of the oscillation signal LO by (π/2). The adder 143 adds an output from the first multiplier 141 to an output from the second multiplier 142, and the amplifier 144 amplifies the output from the adder 143 and outputs a high-frequency modulation signal IF/RF.

When the local frequency of the oscillator OSC is an intermediate frequency, the modulation signal IF/RF may have an intermediate frequency. In addition, the modulation signal IF/RF is up-converted to the carrier frequency by a subsequent-stage circuit, not illustrated in FIG. 2, and transmitted from an antenna to a communication medium. When the local frequency of the oscillator OSC is the carrier frequency, the modulation signal IF/RF may have the carrier frequency. In addition, the modulation signal IF/RF is transmitted from the antenna to the communication medium.

High-frequency components may be extracted from outputs from the multipliers 141 and 142 by high-pass filters not illustrated in FIG. 2.

In the transmission circuit illustrated in FIG. 2, when the baseband signal processing circuit 100 and the quadrature modulation circuit 14 are included in different LSIs respectively, a DC offset component in a modulation signal may be generated in response to a difference between the reference voltages of the LSIs. When the transmission circuit is housed in the small chassis of a mobile terminal device, the temperature in the chassis may increase during an operation, the characteristic of a mixer such as a multiplier widely may fluctuate, and a DC offset component may be generated. The DC offset component may turn out to be a carrier leak, and a bit error rate (BER) in the reception circuit may increase.

A temperature sensor is provided adjacent to the quadrature modulation circuit 14 in the chassis in order to reduce the carrier leak. The correction of temperature fluctuation components for the baseband signals of the I component and the Q component may cause the carrier leak to be reduced. An uniform correction may not cause carrier leaks, which vary among individual devices, to be reduced.

By monitoring the DC component of the quadrature modulation signal IF/RF output from the quadrature modulator 14, the baseband signal may be corrected in response to the detected DC component. When the baseband signals of the I component and the Q component are set to no-signal states, the DC level of an output signal from the quadrature modulation circuit may turn out to be “0”.

When the baseband signals of the I component and the Q component are set to no-signal states, a carrier leak due to the high-frequency characteristic of the multiplier 141 or the multiplier 142 or the like may not be detected.

When the level detection circuit 18 illustrated in FIG. 2 includes an A/D converter that analog-digital-converts the quadrature modulation signal IF/RF having a high-frequency, a carrier leak may be detected while the baseband signals of the I component and the Q component are input.

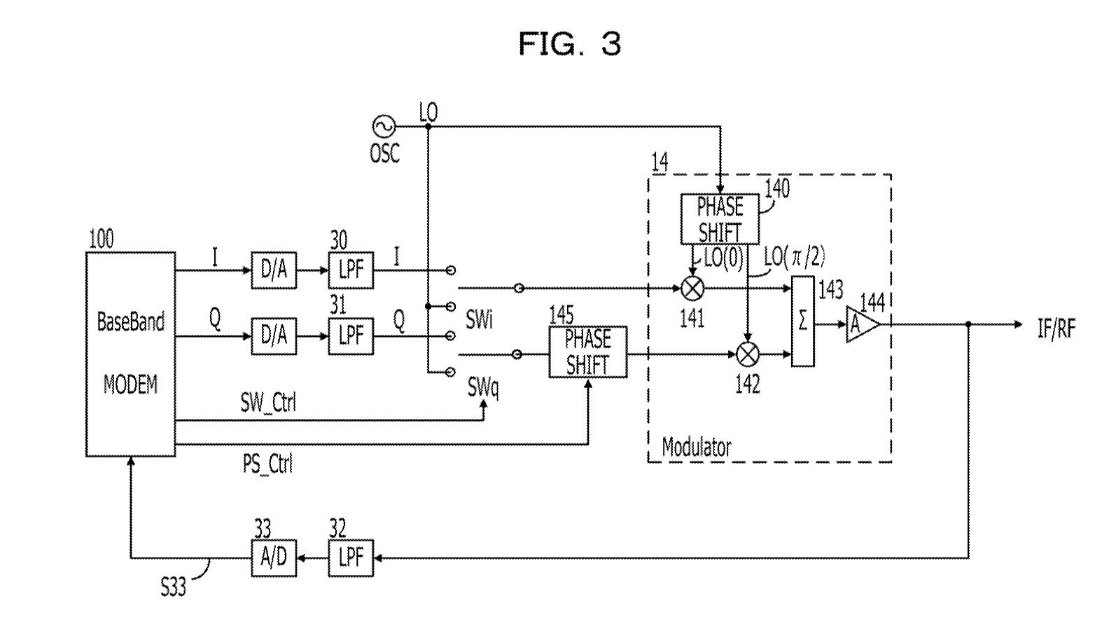

FIG. 3 illustrates an exemplary transmission circuit. The transmission circuit illustrated in FIG. 3 includes a baseband signal processing circuit 100, digital-analog converters D/A, low-pass filters 30 and 31, and a quadrature modulation circuit 14. The baseband signal processing circuit 100 generates the baseband signals of the digital I component and the digital Q component. The digital-analog converters D/A convert the baseband signals to analog signals. The low-pass filters 30 and 31 remove high-frequency components from outputs from the digital-analog converters D/A. The quadrature modulation circuit 14 includes a phase shifter 140 that generates a second local frequency signal LO (π/2) by shifting the phase of an oscillation signal LO by 90 degrees (π/2), a first multiplier or a first mixer 141, a second multiplier or a second mixer 142, an adder 143, and an amplifier 144.

The transmission circuit illustrated in FIG. 3 includes a first switch SWi, a second switch SWq, and a phase shifter 145 provided on a Q signal side. The first switch SWi selects one of the baseband signal of the analog I component, which is an output from the low-pass filter 30, and the oscillation signal LO of the local oscillator OSC. The second switch SWq selects one of the baseband signal of the analog Q component, which is an output from the low-pass filter 31, and the oscillation signal LO.

In a normal operation mode, the first switch SWi and the second switch SWq select the baseband signals of the I component and the Q component, which are outputs from the low-pass filters 30 and 31, respectively. In a correction operation mode, the first switch SWi and the second switch SWq select the oscillation signal LO. The first switch SWi and the second switch SWq are controlled based on a switch control signal SW_Ctrl supplied from the baseband processing circuit 100. In the normal operation mode, the phase shifter 145 allows the baseband signal of the Q component to pass therethrough with the phase of the baseband signal not being shifted. In the correction operation mode, the phase shifter 145 allows the oscillation signal LO to pass therethrough with the phase of the oscillation signal LO being shifted by 90 degrees. The phase shifter 145 is controlled based on a phase shift control signal PS_Ctrl supplied from the baseband processing circuit 100.

The transmission circuit includes a low-pass filter 32, which removes a high-frequency component from the output IF/RF of the quadrature modulation circuit 14, and an A/D converter 33 that analog-digital-converts an output from the low-pass filter 32. A digital output S33 from the A/D converter 33 is fed back to the baseband processing circuit 100 and used for correcting the DC offset component.

In the normal operation mode, the first switch SWi and the second switch SWq select the baseband signals of the I component and the Q component, which are outputs from the low-pass filters 30 and 31 respectively, based on the switch control signal SW_Ctrl. The phase shifter 145 may not perform a phase-shift operation. The baseband signals of the I component and the Q component are input to the first multiplier 141 and the second multiplier 142, respectively. The phase shifter 140 outputs to the first multiplier 141 the first local frequency signal LO (0) obtained by not shifting the phase of the oscillation signal LO. The phase shifter 140 outputs to the second multiplier 142 the second local frequency signal LO (π/2) obtained by shifting the phase of the oscillation signal LO by 90degrees. The adder 143 adds an output from the first multiplier 141 to an output from the second multiplier 142, the amplifier 144 amplifies the addition signal, and the quadrature modulation output signal IF/RF is output. In the normal operation mode, a normal quadrature modulation may be performed.

In the correction operation mode, the switches SWi and SWq select the oscillation signal LO based on the switch control signal SW_Ctrl. The phase shifter 145 may shift the phase of the oscillation signal LO by 90 degrees based on the phase shift control signal PS_Ctrl. The oscillation signal LO (0) and the phase-shifted oscillation signal LO (π/2) are input to the first multiplier 141 and the second multiplier 142, respectively. The phase shifter 140 may be in the normal operation mode.

For example, when the oscillation signal LO is “sin (X)”, the LO (0) is “sin (X)” and the LO (π/2) is “cos (X)”. Therefore, the output from the first multiplier 141 turns out to be “sin² (X)” and the output from the second multiplier 142 turns out to be “cos² (X)”. The output signal IF/RF from the quadrature modulation circuit, obtained by adding the output from the first multiplier 141 to the output from the second multiplier 142, may turn out to be “cos² (X)+sin² (X)=1”.

A value “1” in the output signal IF/RF may correspond to the amplitude “1” of the oscillation signal LO when the oscillation signal LO is “sin (X)”, or correspond to a DC component signal without high-frequency component. The A/D converter 33 may convert the DC component to the digital signal S33 and supply the digital signal S33 to the baseband signal processing circuit 100. Since the first multiplier 141 and the second multiplier 142 in the quadrature modulation circuit 14 perform multiplication operations of the high-frequency signals LO (0) and LO (π/2) in the normal operation mode respectively, a highly accurate DC component may be output.

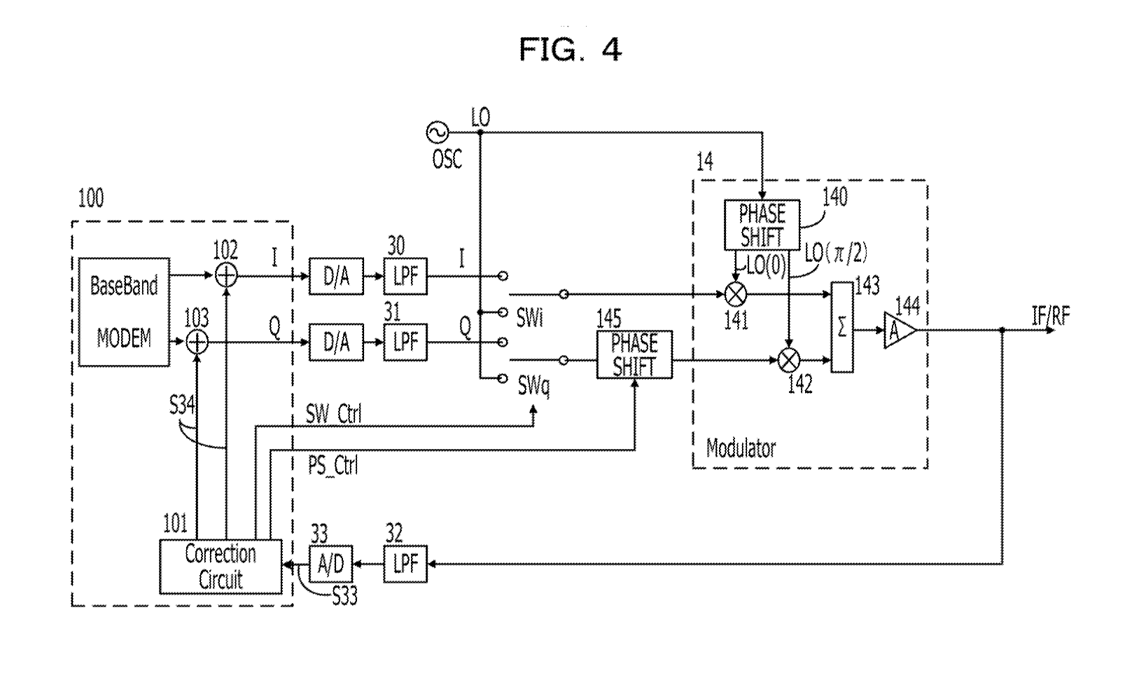

FIG. 4 illustrates an exemplary correction circuit. The correction circuit illustrated in FIG. 4 may be included in the transmission circuit illustrated in FIG. 3. In the transmission circuit illustrated in FIG. 4, the correction circuit in the baseband signal processing circuit 100 is illustrated. Other elements may be substantially the same as or similar to those illustrated in FIG. 3.

The output signal IF/RF from the quadrature modulation circuit 14 may include a DC component signal in the correction operation mode. The DC component data S33, which is a digital output signal from the A/D converter 33, is input to the correction circuit 101. The correction circuit 101 compares the detected DC component data S33 with a value corresponding to the amplitude “1”. A DC correction component S34 is supplied to adders 102 and 103 based on the comparison result. Accordingly, the DC components of the digital I component and digital Q component, which are generated by the baseband signal processing circuit 100, are corrected. The correction circuit 101 corrects the DC correction component S34 to be added so that the detected DC component data S33 substantially matches the value, for example, a difference between the detected DC component data S33 and the value corresponding to the amplitude “1” becomes zero.

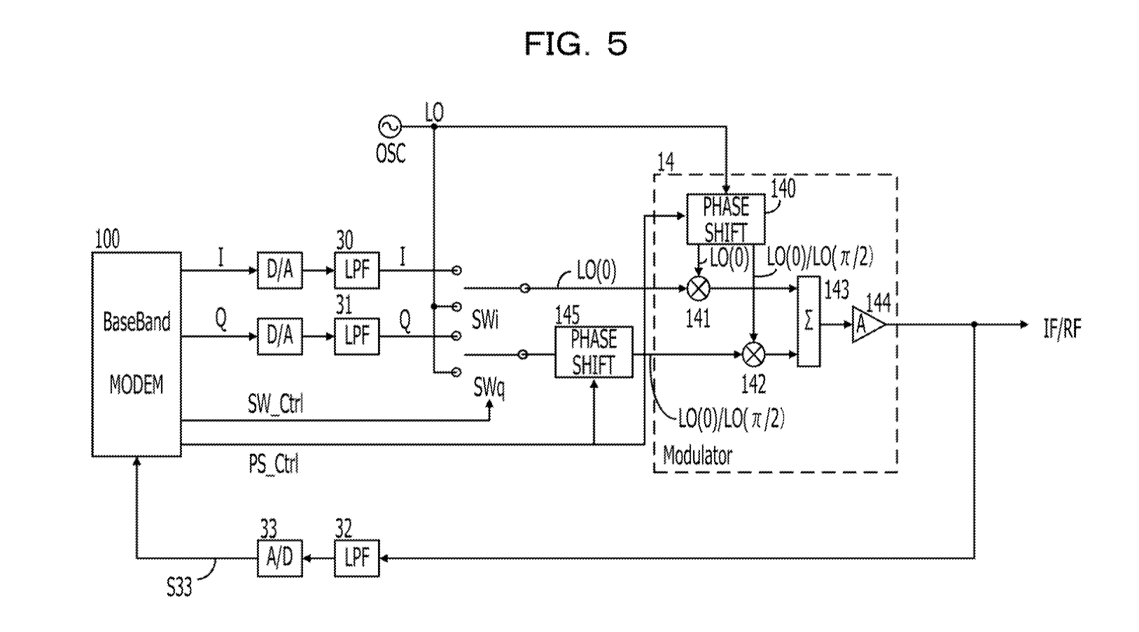

FIG. 5 illustrates an exemplary transmission circuit. In the transmission circuit illustrated in FIG. 5, the phase shifter 140 in the quadrature modulation circuit 14 may be controlled based on the phase shift control signal PS_Ctrl. In the correction operation mode, the phase shifter 140 may output the oscillation signal LO to the first multiplier 141 and the second multiplier 142 without the phase of the oscillation signal LO being shifted. In the normal operation mode, the phase shifter 140 may shift the phase of the oscillation signal LO by 90 degrees to generate the local frequency signal LO (π/2).

In the transmission circuit illustrated in FIG. 5, the phase shifters 140 and 145 may not shift the phases of input signals in the correction operation mode. In the correction operation mode, the first switch SWi and the second switch SWq may select the oscillation signal LO.

For example, when the oscillation signal LO is “sin (X)”, the oscillation signal LO (0) that is “sin (X)” turns out to be used as the multiplier value and the multiplicand value in the first multiplier 141 and the second multiplier 142. Therefore, the outputs of the first multiplier 141 and the second multiplier 142 may turn out to be “sin² (X)”. The output signal IF/RF from the quadrature modulation circuit in which the output of the first multiplier 141 is added to the output of the second multiplier 142 turns out to be “sin² (X)+sin² (X)=1−cos(2*X)”.

When the output signal IF/RF passes through the low-pass filter 32, “cos (2*X)”, which is a high-frequency component, is removed and a DC component corresponding to the amplitude “1” is extracted. The correction circuit in the digital signal processing circuit 100 corrects the DC components in the baseband signals of the I component and the Q component based on the DC component data S33 from the A/D converter 33.

In the transmission circuit illustrated in FIG. 5, the phase-shift operations performed in the phase shifters 140 and 145 are controlled by the phase shift control signal PS_Ctrl. Accordingly, the correction operation mode illustrated in FIG. 3, for example, a first correction operation mode and the correction operation mode illustrated in FIG. 4, for example, a second correction operation mode are set.

In the first correction operation mode, the output signal IF/RF from the quadrature modulation circuit is set to “cos² (X)+sin² (X)=1”. In the second correction operation mode, the output signal IF/RF from the quadrature modulation circuit is set to “sin² (X)+sin² (X)=1−cos(2*X)”.

The correction circuit in the digital signal processing circuit 100 reduces the DC offset of the output signal IF/RF based on the average value of the DC component data S33 in the output signal IF/RF, which is detected in the first correction operation mode or the second correction operation mode. The DC component data, which is generated when the quadrature modulation circuit 14 performs modulation processing for different signals, is corrected based on the average value of DC component data, which is detected in the first correction operation mode and/or the second correction operation mode. Therefore, a carrier leak component generated in the normal operation mode may be suitably removed.

The correction circuit in the digital signal processing circuit 100 reduces the DC offset of the output signal IF/RF based on the DC component data S33 in the output signal IF/RF, which is detected in the first correction operation mode or the second correction operation mode.

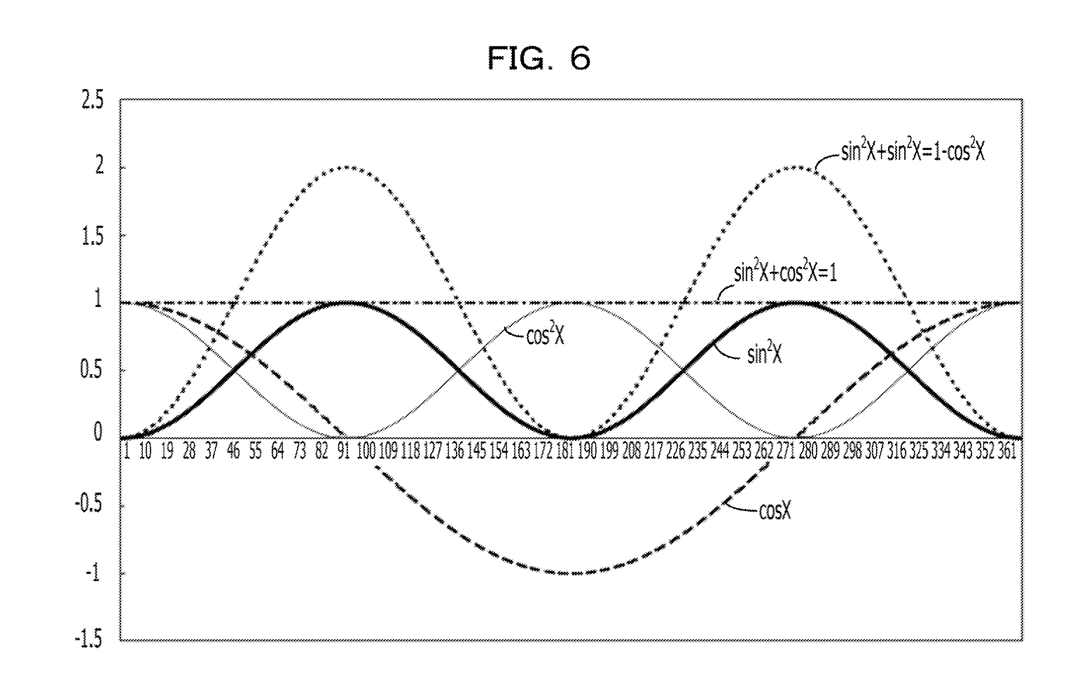

FIG. 6 illustrates exemplary signal waveforms in a transmission circuit. The signal waveforms illustrated in FIG. 6 may be the signal waveforms of the transmission circuit illustrated in FIG. 5 or 3. A horizontal axis in FIG. 6 indicates a time scale. A vertical axis in FIG. 6 indicates a voltage. A value “1” on the vertical axis may correspond to the amplitude “1” of the oscillation signal LO. In FIG. 6, when the oscillation signal LO is equal to “sin (X)”, signals “cos (X)”, “cos² (X)”, “sin² (X)”, “cos² (X)+sin² (X)=1”, and “sin² (X)+sin² (X)=1−cos (2* X)” are Illustrated. The output signals “cos² (X)+sin² (X)=1” and “sin² (X)+sin² (X)=1−cos (2* X)” may have amplitudes “1” as DC components.

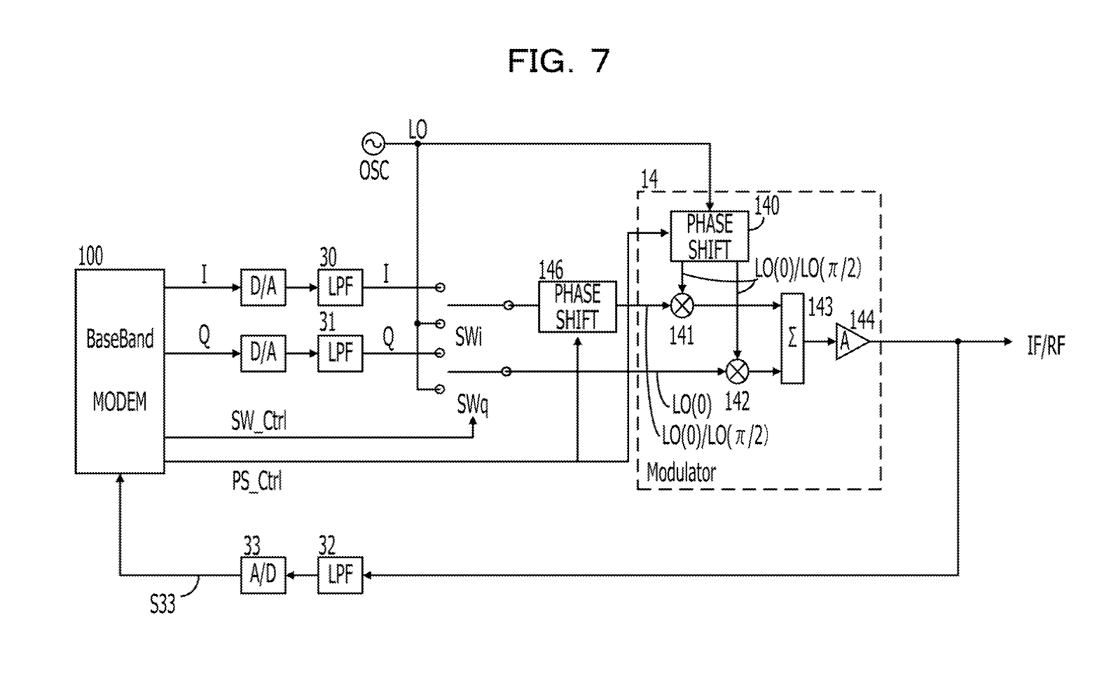

FIG. 7 illustrates an exemplary transmission circuit. In the transmission circuit illustrated in FIG. 7, a phase shifter 146 is provided on an I component side. Other elements illustrated in FIG. 7 may be substantially the same as or similar to those illustrated in FIG. 5.

In the normal operation mode, the first switch SWi and the second switch SWq select the baseband signals of the I component and the Q component, which are outputs from the low-pass filters 30 and 31, respectively. The phase shifter 140 outputs the oscillation signal LO to the first multiplier 141 without the phase of the oscillation signal LO being shifted. The phase shifter 140 outputs the oscillation signal LO to the second multiplier 142 with the phase of the oscillation signal LO being shifted by 90 degrees.

In the correction operation mode, the first switch SWi and the second switch SWq select the oscillation signal LO. In the first correction operation mode, the phase shifter 146 outputs the oscillation signal LO to the first multiplier 141 with the phase of the oscillation signal LO being shifted by 90 degrees. The phase shifter 140 outputs the oscillation signal LO to the first multiplier 141 with the phase of the oscillation signal LO being shifted by 90 degrees, and the phase shifter 140 outputs the oscillation signal LO to the second multiplier 142 without the phase of the oscillation signal LO being shifted. When the oscillation signal LO is set to “sin (X)”, the output of the first multiplier 141 turns out to be “cos² (X)” and the output of the second multiplier 142 turns out to be “sin² (X)”. The output signal IF/RF from the quadrature modulation circuit, which is obtained by adding the output from the first multiplier 141 to the output from the second multiplier 142, turns out to be “cos² (X)+sin² (X)=1”.

In the second correction operation mode, the phase shifter 146 outputs the oscillation signal LO to the first multiplier 141 without the phase of the oscillation signal LO being shifted. The phase shifter 140 outputs the oscillation signal LO to the second multiplier 141 without the phase of the oscillation signal LO being shifted. When the oscillation signal LO is set to “sin (X)”, the outputs of the first multiplier 141 and the second multiplier 142 turn out to be “sin² (X)”. The output signal IF/RF from the quadrature modulation circuit, which is obtained by adding the output from the first multiplier 141 to the output from the second multiplier 142, turns out to be “sin² (X)+sin² (X)=1−cos (2* X)”.

The correction circuit in the digital signal processing circuit 100 may reduce the DC offset of the output signal IF/RF based on the average value of the DC component data S33 in the output signal IF/RF, which is detected in the first correction operation mode or the second correction operation mode.

The correction circuit in the digital signal processing circuit 100 may reduce the DC offset of the output signal IF/RF based on the DC component data S33 in the output signal IF/RF, which is detected in the first correction operation mode or the second correction operation mode.

As illustrated in FIG. 5 or 7, the phase shifters 145 and 146 may be provided on the Q component side or the I component side. In the correction operation mode, the phase shifter 140 in the quadrature modulation circuit 14 may perform a phase-shift operation different from that in the normal operation mode. In the phase shifter 140 in the quadrature modulation circuit 14 illustrated in FIG. 3, a phase-shift operation performed in the normal operation mode may be substantially the same as or similar to a phase-shift operation performed in the correction operation mode.

As long as at least the first switch Swi, the second switch SWq, and the phase shifters 145 and 147 are provided, the DC offset of the output signal from the quadrature modulation circuit 14 in which a high-frequency operation is performed is detected. Therefore, a carrier leak may be reduced.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

1. A transmission circuit comprising:
a first switch configured to select one of a first baseband signal and an oscillation signal;
a second switch configured to select one of a second baseband signal and the oscillation signal;
a first multiplier configured to multiply a first local frequency signal by the signal selected by the first switch, the first local frequency signal being based on the oscillation signal;
a second multiplier configured to multiply a second local frequency signal by the signal selected by the second switch, the second local frequency signal being based on the oscillation signal;
an adder configured to add an output from the first multiplier to an output from the second multiplier; and
a correction circuit configured to correct one of the first baseband signal and the second baseband signal based on an output from the adder when the first switch and the second switch select the oscillation signal.

2. The transmission circuit according to claim 1, further comprising:
a low-pass filter configured to receive the output from the adder; and
an analog-to-digital (A/D) converter configured to convert an output from the low-pass filter to a digital output,
wherein the correction circuit outputs a correction signal used for correcting one of the first baseband signal and the second baseband signal based on a difference between a reference signal and the digital output from the A/D converter when the first switch and the second switch select the oscillation signal.

3. The transmission circuit according to claim 1, further comprising:
a first phase shifter configured to output the second local frequency signal obtained by shifting a phase of the oscillation signal by 90 degrees; and
a second phase shifter configured to shift the phase of the oscillation signal selected by the second switch by 90 degrees and to output the phase-shifted oscillation signal to the second multiplier when the first switch and the second switch select the oscillation signal.

4. The transmission circuit according to claim 1, further comprising:
a first phase shifter configured to output the second local frequency signal,
wherein the first phase shifter shifts a phase of the oscillation signal by 90 degrees to output the phase-shifted oscillation signal as the second local frequency signal when the first switch selects the first baseband signal and the second switch selects the second baseband signal, and
wherein the first phase shifter outputs the oscillation signal as the second local frequency signal when the first switch and the second switch select the oscillation signal.

5. The transmission circuit according to claim 1,
wherein the first switch selects the first baseband signal and the second switch selects the second baseband signal in a normal operation mode, and
wherein the first switch and the second switch select the oscillation signal in a correction operation mode.

6. A transmission circuit for modulating one of a first baseband signal and a second baseband signal which includes at least one of an I component and a Q component, the transmission circuit comprising:
a first phase shifter configured to generate a first phase-shifted oscillation signal by shifting the phase of an oscillation signal by 90 degrees;
a first multiplier configured to multiply the first baseband signal by the oscillation signal;
a second multiplier configured to multiply the second baseband signal by the first phase-shifted oscillation signal;
an adder configured to add an output from the first multiplier to an output from the second multiplier and to output a quadrature modulation signal; and
a correction circuit configured to correct one of the first baseband signal and the second baseband signal based on the quadrature modulation signal,
wherein in a correction operation mode, the oscillation signal is input in place of the first baseband signal to the first multiplier and one of the oscillation signal and a second phase-shifted oscillation signal, which is obtained by shifting the phase of the oscillation signal by 90 degrees, is supplied in place of the second baseband signal to the second multiplier.

7. The transmission circuit according to claim 6, wherein
the quadrature modulation signal is indicated by at least one of “sin² (X) +cos² (X)” and “sin² (X)+sin² (X)” when the oscillation signal is “sin (X)”.

8. A transmission circuit for modulating one of a first baseband signal and a second baseband signal which includes one of an I component and a Q component, the transmission circuit comprising:
a first phase shifter configured to generate a first phase-shifted oscillation signal by shifting the phase of an oscillation signal by 90 degrees;
a first multiplier configured to multiply the first baseband signal by the oscillation signal;
a second multiplier configured to multiply the second baseband signal by the first phase-shifted oscillation signal;
an adder configured to add an output from the first multiplier to an output from the second multiplier and to output a quadrature modulation signal; and
a correction circuit configured to correct one of the first baseband signal and the second baseband signal based on the quadrature modulation signal,
wherein in a first correction operation mode, the oscillation signal is input in place of the first baseband signal to the first multiplier, the oscillation signal is supplied in place of the second baseband signal to the second multiplier, and the oscillation signal is supplied in place of the first phase-shifted oscillation signal to the second multiplier.

9. The transmission circuit according to claim 8, wherein
the quadrature modulation signal is indicated by “sin² (X)+sin² (X)” when the oscillation signal is “sin (X)”.

10. The transmission circuit according to claim 8, wherein
the oscillation signal is input in place of the first baseband signal to the first multiplier and a second phase-shifted oscillation signal is supplied in place of the second baseband signal to the second multiplier in a second correction operation mode, the second phase-shifted oscillation signal being obtained by shifting the phase of the oscillation signal by 90 degrees, and
wherein the quadrature modulation signal is indicated by “sin² (X)+cos² (X)” when the oscillation signal is “sin (X)”.

11. The transmission circuit according to claim 10, wherein
the correction circuit corrects direct-current components of the first baseband signal and the second baseband signal based on average values of the quadrature modulation signal in the first correction operation mode and the second correction operation mode.

12. The transmission circuit according to claim 6, wherein the correction operation mode is set at a power-on time or when a transmission operation is deactivated after power-on.

13. The transmission circuit according to claim 6, further comprising:
a first switch configured to select one of the first baseband signal and the oscillation signal; and
a second switch configured to select one of the second baseband signal and the oscillation signal,
wherein the first switch selects the first baseband signal and the second switch selects the second baseband signal in a normal operation mode; and
the first switch and the second switch select the oscillation signal in the correction operation mode.

14. The transmission circuit according to claim 8, wherein
one of the first correction operation mode and a second correction operation mode is set at power-on time or when a transmission operation is deactivated after power-on.

15. The transmission circuit according to claim 8, further comprising:
a first switch configured to select one of the first baseband signal and the oscillation signal; and
a second switch configured to select one of the second baseband signal and the oscillation signal,
wherein the first switch selects the first baseband signal and the second switch selects the second baseband signal in a normal operation, and
the first switch and the second switch select the oscillation signal in the first correction operation mode or the second correction operation mode.

16. The transmission circuit according to claim 6, wherein
the correction circuit includes
a low-pass filter configured to extract a low-frequency component of the quadrature modulation signal;
a correction signal generation circuit configured to generate a correction signal indicating a difference between an output signal from the low-pass filter and a reference signal; and
a correction adder configured to add the correction signal to one of the first baseband signal and the second baseband signal.

17. The transmission circuit according to claim 6, wherein
the correction circuit includes
a low-pass filter configured to extract the low-frequency component of the quadrature modulation signal; and
a correction signal generation circuit configured to generate a correction signal indicating a difference between an output signal from the low-pass filter and a reference signal,
wherein the direct-current component of the first baseband signal or the second baseband signal is corrected based on the correction signal.

18. The transmission circuit according to claim 8, wherein
the correction circuit includes
a low-pass filter configured to extract the low-frequency component of the quadrature modulation signal;
a correction signal generation circuit configured to generate a correction signal indicating a difference between an output signal from the low-pass filter and a reference signal; and
a correction adder configured to add the correction signal to the first baseband signal or the second baseband signal.

19. The transmission circuit according to claim 8, wherein
the correction circuit includes
a low-pass filter configured to extract the low-frequency component of the quadrature modulation signal; and
a correction signal generation circuit configured to generate a correction signal indicating a difference between an output signal from the low-pass filter and a reference signal,
wherein the direct-current component of the first baseband signal or the second baseband signal is corrected based on the correction signal.

20. A method for modulating signals for transmission, comprising:
first selecting one of a first baseband signal and an oscillation signal;
second selecting one of a second baseband signal and the oscillation signal;
first multiplying a first local frequency signal by the signal selected in the first selecting, the first local frequency signal is based on the oscillation signal;
second multiplying a second local frequency signal by the signal selected in the second selecting, the second local frequency signal is based on the oscillation signal;
correcting, with a correction circuit, one of the first baseband signal and the second baseband signal based on a result of the first multiplying and a result of the second multiplying once the oscillation signal is selected from both the first selecting and the second selecting.
